(19) United States
(12) Patent Application Publication
(10) Pub. No.: US 2026/0307987 A1
(43) Pub. Date: Oct. 8, 2026

(54) Steam-Hydrocarbon Reforming with Reduced Carbon Dioxide Emissions

(71) Applicant: Air Products and Chemicals, Inc., Allentown, PA (US)

(72) Inventors: Sonia Farrokhpanah, Surbiton (GB); Kelly Ann Forester, Harleysville, PA (US); David Ross Graham, Harlysville, PA (US); Michelle Schoonover, Macungie, PA (US); Donald E. Henry, Allentown, PA (US)

(73) Assignee: Air Products and Chemicals, Inc., Allentown, PA (US)

(21) Appl. No.: 18/998,542

(22) PCT Filed: Aug. 2, 2022
(86) PCT No.: PCT/IB2022/057171

§ 371 Date: Jan. 27, 2025

(51) Int. Cl. C01B 3/48; B01D 53/22; B01J 8/04; B01J 8/06; C01B 3/501

(52) U.S. Cl. CPC C01B 3/48; B01D 53/229; B01J 8/0492; B01J 8/0496; B01J 8/065; B01J 8/067; C01B 3/501; B01D 2053/221; B01D 2256/16; B01D 2257/504; B01J 2208/00504; B01J 2208/065; C01B 2203/0233; C01B 2203/0238; C01B 2203/0288; C01B 2203/0405; C01B 2203/044; C01B 2203/047; C01B 2203/0475; C01B 2203/0822; C01B 2203/1017; C01B 2203/1241; C01B 2203/148

(57) ABSTRACT

A low carbon-emission hydrogen production process may be achieved by first separating carbon dioxide from a reformer syngas stream, followed by purifying the carbon dioxide-depleted syngas stream to produce a hydrogen product and a hydrogen-depleted tail gas stream. The hydrogen-depleted tail gas stream is then separated using a semi-permeable membrane after which the hydrogen-enriched permeate is used as fuel in the reformer burners and the hydrogen-depleted retentate is recycled to the feed.

### BACKGROUND

Existing industrial processes such as reforming hydrocarbon feeds to produce hydrogen and syngas will need to capture carbon dioxide (CO2) to mitigate the effects of climate change. Steam methane reforming (SMR) is the most common reforming technology, but uses air-fired combustion of a fuel gas to generate the heat needed to drive the reforming reactions. Air-fired combustion generates a flue gas in which any carbon in the fuel gas is converted to CO2 at low pressure and concentration due to the high amounts of inert nitrogen contributed by the air. Carbon capture from flue gas is costly, inefficient, and bulky. Eliminating carbon from the fuel gas in air-fired combustion enables efficient capture of nearly 100% of the CO2 in the process by capturing CO2 in the syngas which has CO2 at a much higher concentration and pressure.

Licht et al. (U.S. Pat. No. 8,137,422) teach a process for reducing emissions from an SMR process by recycling the hydrogen-depleted waste stream, or tail gas, from a hydrogen purification step to a point upstream or downstream of the SMR and using product hydrogen to supply a significant fraction of the fuel gas.

Adamopoulos et al. (U.S. Pat. No. 9,517,933) teach a process for recovering hydrogen from a tail gas from a hydrogen purification step to improve overall hydrogen recovery. The non-permeate stream is recycled to a point downstream of the catalytic reformer.

Guo et al. (WO 2013/131916) teach a process for operating an SMR process with a high-pressure tail gas that is separated in a membrane system without using a compressor. The permeate stream is used as a fuel gas in the furnace and the non-permeate stream is recycled to the SMR feed.

There exists a need to produce hydrogen using an SMR process that reduces CO2 emissions with a minimal increase in overall energy cost, defined herein as the net energy (hydrocarbon feed and fuel consumed minus the steam exported) in MJ divided by the total hydrogen product in kg.

### SUMMARY

The present disclosure relates to a process and apparatus that use a membrane to separate the tail gas from a hydrogen purification step downstream of a reformer into a hydrogen-enriched permeate stream and a hydrogen-depleted non-permeate stream. In at least some embodiments, the hydrogen-enriched permeate stream may then be combusted in the reformer to generate heat for the reforming reactions and the hydrogen-depleted non-permeate stream may then be recycled to the SMR process.

Aspect 1: A process for producing a hydrogen-enriched product stream, the process comprising reacting a reformer feed stream comprising a hydrocarbon feestock and a reactant selected from the group consisting of water and carbon dioxide in the presence of a reforming catalyst to produce a syngas stream comprising hydrogen, carbon monoxide, and carbon dioxide; separating the syngas stream or a stream derived from the syngas stream to produce a carbon dioxide-enriched stream and a carbon dioxide-depleted stream; separating the carbon dioxide-depleted stream to produce the hydrogen-enriched product stream and a hydrogen-depleted tail gas stream; separating the hydrogen-depleted tail gas stream by selective permeation to produce a hydrogen-enriched permeate stream and a hydrogen-depleted retentate stream; combusting a fuel gas to supply heat to the reaction of the reformer feed stream; wherein the fuel gas comprises at least a portion of the hydrogen-enriched permeate stream.

Aspect 2: A process for producing a hydrogen-enriched product stream, the process comprising reacting a reformer feed stream comprising a hydrocarbon feestock and a reactant selected from the group consisting of water and carbon dioxide in the presence of a reforming catalyst to produce a syngas stream comprising hydrogen, carbon monoxide, and carbon dioxide; reacting the syngas stream or a stream derived from the syngas stream in the presence of a first shift catalyst to produce a shifted syngas stream; separating the shifted syngas stream to produce a carbon dioxide-enriched stream and a carbon dioxide-depleted stream; separating the carbon dioxide-depleted stream to produce the hydrogen-enriched product stream and a hydrogen-depleted tail gas stream; separating the hydrogen-depleted tail gas stream by selective permeation to produce a hydrogen-enriched permeate stream and a hydrogen-depleted retentate stream; combusting a fuel gas to supply heat to the reaction of the reformer feed stream; wherein the fuel gas comprises at least a portion of the hydrogen-enriched permeate stream.

Aspect 3: A process for producing a hydrogen-enriched product stream, the process comprising reacting a reformer feed stream comprising a hydrocarbon feestock and a reactant selected from the group consisting of water and carbon dioxide in the presence of a reforming catalyst to produce a syngas stream comprising hydrogen, carbon monoxide, and carbon dioxide; reacting the syngas stream or a stream derived from the syngas stream in the presence of a first shift catalyst to produce a shifted syngas stream; reacting the shifted syngas stream in the presence of a second shift catalyst to produce a further shifted syngas stream; separating the further shifted syngas stream to produce a carbon dioxide-enriched stream and a carbon dioxide-depleted stream; separating the carbon dioxide-depleted stream to produce the hydrogen-enriched product stream and a hydrogen-depleted tail gas stream; separating the hydrogen-depleted tail gas stream by selective permeation to produce a hydrogen-enriched permeate stream and a hydrogen-depleted retentate stream; combusting a fuel gas to supply heat to the reaction of the reformer feed stream; wherein the fuel gas comprises at least a portion of the hydrogen-enriched permeate stream.

Aspect 4: A process for producing a hydrogen-enriched product stream, the process comprising reacting a reformer feed stream comprising a hydrocarbon feestock and a reactant selected from the group consisting of water and carbon dioxide in the presence of a reforming catalyst to produce a syngas stream comprising hydrogen, carbon monoxide, and carbon dioxide; combining an oxygen-rich gas with the syngas stream in the presence of a secondary reforming catalyst to partially oxidize and react the syngas stream to produce a reacted syngas stream; reacting the reacted syngas stream in the presence of a first shift catalyst to produce a shifted syngas stream; reacting the shifted syngas stream in the presence of a second shift catalyst to produce a further shifted syngas stream; separating the further shifted syngas stream to produce a carbon dioxide-enriched stream and a carbon dioxide-depleted stream; separating the carbon dioxide-depleted stream to produce the hydrogen-enriched product stream and a hydrogen-depleted tail gas stream; separating the hydrogen-depleted tail gas stream by selective permeation to produce a hydrogen-enriched permeate stream and a hydrogen-depleted retentate stream; combusting a fuel gas to supply heat to the reaction of the reformer feed stream; wherein the fuel gas comprises at least a portion of the hydrogen-enriched permeate stream.

Aspect 5: A process for producing a hydrogen-enriched product stream, the process comprising reacting a reformer feed stream comprising a hydrocarbon feestock and a reactant selected from the group consisting of water and carbon dioxide in the presence of a reforming catalyst to produce a syngas stream comprising hydrogen, carbon monoxide, and carbon dioxide; combining an oxygen-rich gas with the syngas stream in the presence of a secondary reforming catalyst to partially oxidize and react the syngas stream to produce a reacted syngas stream; reacting the reacted syngas stream in the presence of a first shift catalyst to produce a shifted syngas stream; separating the shifted syngas stream to produce a carbon dioxide-enriched stream and a carbon dioxide-depleted stream; separating the carbon dioxide-depleted stream to produce the hydrogen-enriched product stream and a hydrogen-depleted tail gas stream; separating the hydrogen-depleted tail gas stream by selective permeation to produce a hydrogen-enriched permeate stream and a hydrogen-depleted retentate stream; combusting a fuel gas to supply heat to the reaction of the reformer feed stream; wherein the fuel gas comprises at least a portion of the hydrogen-enriched permeate stream.

Aspect 6: A process for producing a hydrogen-enriched product stream, the process comprising reacting a reformer feed stream comprising a hydrocarbon feestock and a reactant selected from the group consisting of water and carbon dioxide in the presence of a reforming catalyst to produce a syngas stream comprising hydrogen, carbon monoxide, and carbon dioxide; combining an oxygen-rich gas with the syngas stream in the presence of a secondary reforming catalyst to partially oxidize and react the syngas stream to produce a reacted syngas stream; separating the reacted syngas stream to produce a carbon dioxide-enriched stream and a carbon dioxide-depleted stream; separating the carbon dioxide-depleted stream to produce the hydrogen-enriched product stream and a hydrogen-depleted tail gas stream; separating the hydrogen-depleted tail gas stream by selective permeation to produce a hydrogen-enriched permeate stream and a hydrogen-depleted retentate stream; combusting a fuel gas to supply heat to the reaction of the reformer feed stream; wherein the fuel gas comprises at least a portion of the hydrogen-enriched permeate stream.

Aspect 7: A process according to Aspect 3 or 4, wherein the temperature of the syngas stream is greater than the temperature of the shifted syngas stream.

Aspect 8: A process according to any of Aspects 1 to 7, wherein the reaction of the reformer feed stream takes place within a plurality of catalyst-containing reformer tubes.

Aspect 9: A process according to any of Aspects 1 to 8, further comprising combining at least a portion of the hydrogen-depleted retentate stream with the reformer feed stream.

Aspect 10: A process according to any of Aspects 4 to 6, further comprising combining at least a portion of the hydrogen-depleted retentate stream with the reacted syngas stream prior.

Aspect 11: A process according to any of Aspects 1 to 10, further comprising reacting a prereformer feed stream comprising methane and a reactant selected from the group consisting of water and carbon dioxide in the presence of a prereforming catalyst to produce the reformer feed stream.

Aspect 12: A process according to Aspect 11, further comprising combining at least a portion of the hydrogen-depleted retentate stream with the prereformer feed stream.

Aspect 13: A process according to any of Aspects 1 to 12, wherein the separation of the hydrogen-depleted tail gas stream by selective permeation also produces a second hydrogen-enriched permeate stream; and further comprising combining the second hydrogen-enriched permeate stream with the hydrogen-depleted tail gas stream.

Aspect 14: A process according to any of Aspects 1 to 13, further comprising dividing at least a portion of the hydrogen-depleted tail gas stream to form a tail gas fuel fraction; wherein the fuel gas comprises the tail gas fuel fraction.

Aspect 15: An apparatus for producing a hydrogen-enriched product stream, the apparatus comprising a reformer comprising a reforming catalyst and one or more burners, wherein the reformer is configured to accept a reformer feed stream comprising methane and a reactant selected from the group consisting of water and carbon dioxide to contact the reforming catalyst and produce a syngas stream comprising hydrogen, carbon monoxide, and carbon dioxide; wherein the one or more burners are configured to combust a fuel gas and transfer heat energy to the reformer feed stream in the presence of the reforming catalyst; a carbon dioxide removal system configured to accept the syngas stream or a stream derived from the syngas stream to produce a carbon dioxide-enriched stream and a carbon dioxide-depleted stream; a product purification system comprising an inlet port, a product outlet port, and a tail gas outlet port, configured to accept the carbon dioxide-depleted stream to produce a hydrogen-depleted tail gas stream and the hydrogen-enriched product stream; a membrane separation system comprising an inlet port, a permeate outlet port, and a retentate outlet port, configured to accept the hydrogen-depleted tail gas stream to produce a hydrogen-enriched permeate stream and a hydrogen-depleted retentate stream; a tail gas conduit in fluid flow communication with the tail gas outlet of the product purification system and the inlet port of the membrane separation system; and a fuel gas conduit in fluid flow communication with the one or more burners and the permeate outlet port of the membrane separation system.

Aspect 16: An apparatus according to Aspect 15, further comprising one or more water gas shift reactors in series downstream of the reformer and upstream of the carbon dioxide removal system.

Aspect 17: An apparatus according to Aspect 15 or Aspect 16, wherein the reformer comprises a plurality of catalyst-containing reformer tubes.

Aspect 18: An apparatus according to any of Aspects 15 to 17, wherein the retentate outlet port of the membrane separation system is in fluid flow communication with the reformer feed stream.

Aspect 19: An apparatus according to any of Aspects 15 to 18, further comprising a secondary reformer located downstream of the reformer and upstream of the carbon dioxide removal system, configured to accept and partially oxidize and react the syngas stream in the presence of an oxygen-rich gas; wherein the secondary reformer comprises a secondary reforming catalyst.

Aspect 20: An apparatus according to Aspect 19, wherein the retentate outlet port of the membrane separation system is in fluid flow communication with the syngas stream upstream of the secondary reformer.

Aspect 21: An apparatus according to any of Aspects 15 to 20, further comprising a prereformer located upstream of the reformer, configured to accept a prereformer feed stream comprising methane and a reactant selected from the group consisting of water and carbon dioxide to produce the reformer feed stream; wherein the prereformer comprises a prereforming catalyst.

Aspect 22: An apparatus according to Aspect 21, wherein the retentate outlet port of the membrane separation system is in fluid flow communication with the prereformer feed stream.

Aspect 23: An apparatus according to any of Aspects 15 to 22, wherein the tail gas conduit comprises a tail gas compressor.

Aspect 24: An apparatus according to any of Aspects 15 to 23, wherein the membrane separation system comprises a second permeate outlet port; wherein the second permeate outlet port is in fluid flow communication with the tail gas conduit.

Aspect 25: An apparatus according to any of Aspects 15 to 24, wherein the one or more burners are in fluid flow communication with the tail gas conduit.

### BRIEF DESCRIPTION OF THE DRAWINGS

The present disclosure will hereinafter be described in conjunction with the appended figures wherein like numerals denote like elements:

FIG. 1 is a diagram depicting an embodiment of a reforming process according to one or more aspects of the present disclosure in which a portion of the tail gas is compressed and separated in a membrane. A hydrogen-enriched permeate is used as a fuel gas and the hydrogen-depleted retentate stream is recycled to a reformer feed.

FIG. 2 is a diagram depicting a modification of the embodiment in FIG. 1 in which the hydrogen-depleted retentate stream is recycled to a prereformer feed.

FIG. 3 is a diagram depicting a modification of the embodiment in FIG. 1 in which the hydrogen-depleted retentate stream is recycled to a secondary reforming reactor feed.

FIG. 4 is a diagram depicting a modification of the embodiment in FIG. 1 in which carbon dioxide is captured using an adsorption system.

FIG. 5 is a diagram depicting a modification of the embodiment in FIG. 1 in which a second hydrogen-enriched permeate is removed from a second stage membrane and recycled to the tail gas.

FIG. 6 is a diagram depicting a modification of the embodiment in FIG. 1 in which a portion of the reformer feed is fed to a recuperative reformer and heated by a syngas stream.

FIG. 7 is a diagram depicting a modification of the embodiment in FIG. 6 in the recuperative reformer is heated by a combination of the syngas and the recuperative reformer outlet gas.

### DETAILED DESCRIPTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. Various changes may be made in the function and arrangement of elements without departing from the spirit and scope of the invention, as set forth in the appended claims.

The articles “a” or “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The phrase “at least a portion” means “a portion or all.” The “at least a portion of a stream” has the same composition, with the same concentration of each of the species, as the stream from which it is derived.

The term “and/or” placed between a first entity and a second entity includes any of the meanings of (1) only the first entity, (2) only the second entity, or (3) the first entity and the second entity. The term “and/or” placed between the last two entities of a list of 3 or more entities means at least one of the entities in the list including any specific combination of entities in this list. For example, “A, B and/or C” has the same meaning as “A and/or B and/or C” and comprises the following combinations of A, B and C: (1) only A, (2) only B, (3) only C, (4) A and B but not C, (5) A and C but not B, (6) B and C but not A, and (7) A and B and C.

The adjective “any” means one, some, or all, indiscriminately of quantity.

The terms “depleted” or “lean” mean having a lesser mole percent concentration of the indicated component than the original stream from which it was formed. “Depleted” and “lean” do not mean that the stream is completely lacking the indicated component.

The terms “rich” or “enriched” mean having a greater mole percent concentration of the indicated component than the original stream from which it was formed.

“Downstream” and “upstream” refer to the intended flow direction of the process fluid transferred. If the intended flow direction of the process fluid is from the first device to the second device, the second device is downstream of the first device. In case of a recycle stream, downstream and upstream refer to the first pass of the process fluid.

The term “indirect heat exchange” refers to the process of transferring sensible heat and/or latent heat between two or more fluids without the fluids in question coming into physical contact with one another. The heat may be transferred through the wall of a heat exchanger or with the use of an intermediate heat transfer fluid. The term “hot stream” refers to any stream that exits the heat exchanger at a lower temperature than it entered. Conversely, a “cold stream” is one that exits the heat exchanger at a higher temperature than it entered.

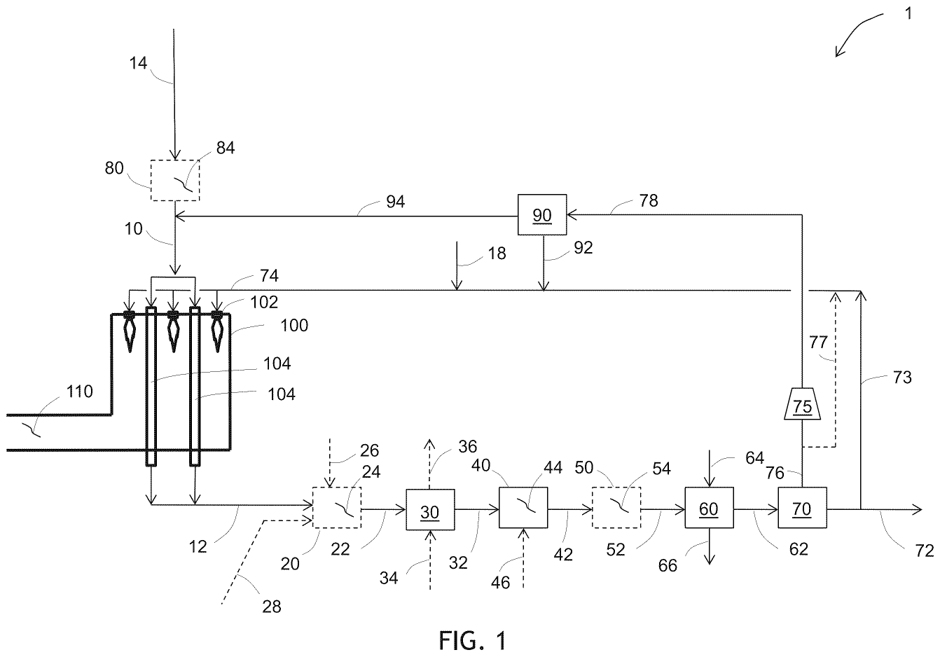

FIG. 1 shows an embodiment of a reforming process 1 that produces hydrogen from a hydrocarbon feedstock and captures carbon dioxide. The hydrocarbon feedstock comprises at least one hydrocarbon species with one or more carbon atoms, and may be straight-chain, branched, cyclic, or aromatic. The hydrocarbon feedstock may comprise both saturated and unsaturated hydrocarbon species. The hydrocarbon feedstock may be derived from natural gas, liquefied petroleum gas, refinery off gas, naphtha, and/or other feedstocks known in the art.

A reformer feed stream 10 comprising steam and the hydrocarbon feedstock enters a plurality of catalyst-containing reformer tubes 104 in a reformer furnace 100. In the plurality of catalyst-containing reformer tubes 104 the hydrocarbon feedstock reacts with the steam at a temperature ranging from 700° C. to 1000° C. and a pressure ranging from 2 to 50 atmospheres to form a syngas stream 12 comprising hydrogen, carbon monoxide, and carbon dioxide.

Reformer furnaces with a plurality of catalyst-containing reformer tubes, i.e. tubular reformers, are well known in the art. Suitable materials and methods of construction are known. Catalyst in the catalyst-containing reformer tubes 104 may be any suitable catalyst or combination of catalysts known in the art, for example, a supported catalyst comprising nickel.

In at least some embodiments, the reformer feed stream 10 may be produced by an optional prereformer 80, defined as any unfired vessel that converts the hydrocarbon feedstock by reaction with steam over a catalyst with or without heating. The prereformer 80 may be an fixed bed reactor or a tubular reactor. The prereformer may, in at least some aspects, employ a different type of catalyst than the catalyst-containing reformer tubes 104, for example a high activity, high nickel content catalyst. In the embodiment shown in FIG. 1, a prereformer feed stream 14 comprising steam and a hydrocarbon feedstock enters the prereformer 80. In the presence of a prereforming catalyst 84, the hydrocarbon feedstock reacts with the steam at a temperature ranging from 400° C. to 600° C. and a pressure ranging from 2 to 50 atmospheres to form the reformer feed stream 10. The hydrocarbon feedstock in prereformer feed stream 14 and reformer feed stream 10 may comprise one or more compositions which may vary due to reforming reactions in the prereformer. For example, propane and butane in the prereformer feed stream 14 may react to form methane in the reformer feed stream 10.

Prereforming catalyst 84 may comprise at least one metal selected from a group consisting of nickel, cobalt, platinum, palladium, rhodium, ruthenium, iridium and mixtures thereof. Reforming catalysts suitable for prereforming, such as those discussed in U.S. Pat. Nos. 4,105,591, 3,882,636, 3,988,425, GB 969,637, GB 1,150,066, and GB 1,155,843, may be used in at least some aspects.

Prereforming catalyst 84 may be present in a wide variety of shapes or forms, for example cylindrical pellets, Raschig rings, multi-hole shaped catalyst, etc. or other form known in the art. In at least some example implementations, the catalyst size may range from about 1 mm to about 15 mm in diameter and the length of the catalyst may range from about 3 mm to 10 mm. The preferred size for a given application depends on a number of factors including the catalyst shape and nickel loading, the operating temperature, pressure, and feed composition, and the allowable pressure drop. A catalyst with a multi-hole shape with a diameter in the range from 5 mm to 25 mm and a height to diameter ratio of 0.5 to 1.2 is also suitable for prereforming catalyst 84. One skilled in the art is able to select suitable catalyst with a suitable shape for prereforming catalyst 84.

In at least some example implementations, rereforming catalyst 84 may also be structured packing catalyst where the catalyst is applied as a washcoat on a structured packing. Structured packing is known in the art. As used herein, the term “structured packing” means a flow guide having a plurality of substantially parallel passages. Substantially parallel means parallel within manufacturing tolerances. Davidson, U.S. Pat. No. 4,340,501 describes a structure in a reactor vessel where the fluid is intermittently but controllably brought into contact with the vessel walls that would be suitable for a structured packing prereforming catalyst.

In at least some embodiments, the syngas stream 12 may be further combined with a secondary feed stream 28 and reformed in an optional secondary reforming reactor 20. The secondary reforming reactor 20 may also combine an oxygen-rich gas 26 with the syngas stream 12 to partially oxidize the syngas stream 12 and react it in the presence of a secondary reforming catalyst 24 to further convert unreacted hydrocarbon species to produce carbon monoxide and hydrogen and form a reacted syngas stream 22. In at least some embodiments, the oxygen-rich gas 26 may be combined with the syngas stream 12 before the secondary reforming reactor 20 or may be combined with the syngas stream 12 in the secondary reforming reactor 20, for example through a burner.

The secondary feed stream 28 may be introduced into the syngas stream 12 before the resultant mixture is introduced into the secondary reforming reactor 20. The feed gas 28 may be introduced into the syngas stream 12 in the secondary reforming reactor 20. In most embodiments, the oxygen-rich gas will be introduced into the secondary reforming reactor 20 separately from the secondary feed stream 28 and the syngas stream 12. The hydrocarbon source for the secondary feed stream 28 may be the same as the hydrocarbon source for the reformer feed stream 10 and/or the prereformer feed stream 14.

Providing a feed gas comprising at least one hydrocarbon and reacting the feed gas in the secondary reforming reactor 20 allows additional hydrocarbon feedstock be reformed without increasing the size of the reformer furnace 100 and correspondingly, the plurality of catalyst-containing reformer tubes. One skilled in the art can suitably optimize the size of and amount of feedstock processed in the reformer furnace 100 and the secondary reforming reactor 20. Another benefit provided by the secondary reforming reactor 20 is that fuel requirements in the \reformer furnace 100 are reduced.

Secondary reforming reactors are well-known in the art and used widely for the production of ammonia and methanol. Secondary reforming reactors are refractory lined vessels with one or more burners and a reforming catalyst bed. Heat required for the reforming reaction may be provided by partial oxidation (combustion) of a portion of the feed. Effluent from the primary reformer may be fed to the secondary reforming reactor where it is mixed with oxygen fed through a burner. Partial oxidation reactions occur in a reaction zone adjacent or just below the burner. The partially oxidized mixture then passes through a catalyst bed where the mixture is substantially thermodynamically equilibrated over the reforming catalyst. U.S. Pat. No. 3,479,298, incorporated herein by reference, discloses a secondary reformer for the production of a hydrogen-containing gas, and discloses that if oxygen is used instead of air, the process gas leaving the secondary reformer is a gas suitable for further treatment to yield methanol or high purity hydrogen. Tindall et al., “Alternative technologies to steam-methane reforming,” Hydrocarbon Processing, pp. 75-82, November, 1995, also disclose a oxygen secondary reformer for producing hydrogen.

In at least some embodiments of the present disclosure, the reacted syngas stream 22 is cooled in a heat exchanger system 30 which comprise a boiler to produce steam 36 from a water-containing stream 34 by indirect heat exchange with the reacted syngas stream 22. A cooled syngas stream 32 is produced by the heat exchanger system 30. The heat exchanger system 30 may also utilize the heat from the reacted syngas stream 22 to provide heating duties required by the SMR process to improve the overall thermal efficiency, such as preheating the reformer feed stream 10.

A first water gas shift reactor 40 may be used to react carbon monoxide in the cooled syngas stream 32 with water in the presence of a shift catalyst 44 to produce a shifted syngas stream 42 comprising more hydrogen. The cooled syngas stream 32 enters at a first temperature and, in an example embodiment where the first water gas shift reactor 40 is an adiabatic reactor, the cooled syngas stream 32 increases in temperature due to the exothermic shift reaction. In the case where the first water gas shift reactor 40 is cooled, the cooled syngas stream 32 may remain constant in temperature or be cooled overall. To enhance the water gas shift (WGS) reaction, first additional steam 46 can optionally be introduced to the reactor to shift the equilibrium to more hydrogen and carbon dioxide. The WGS catalyst may be an iron-based high temperature WGS catalyst, or a copper-based medium temperature WGS catalyst, a copper-based low temperature WGS catalyst, or any other suitable WGS catalyst, as may be selected by a person skilled in the art. The first shift catalyst 44 may comprise iron oxide and the reaction temperature may be from 310° C. to 500° C. or 310° C. to 400° C. The first shift catalyst 44 may comprise copper and the reaction temperature may be from 200° C. to 400° C. or 200° C. to 350° C. In at least some example implementations, the shifted syngas stream 42 may enter a second water gas shift reactor 50 with a second shift catalyst 54 at a second temperature to produce a further shifted syngas stream 52. A second additional steam (not shown) can optionally be introduced to the second water gas shift reactor 50. The second temperature may be lower than the first temperature to allow the shifted syngas stream 42 to react more carbon monoxide with water to produce hydrogen, as the equilibrium moves towards hydrogen at lower temperatures. The second shift catalyst 54 may comprise copper and/or zinc oxide and the reaction temperature may range from 190° C. to 300° C. The second temperature may also be at the same or a higher temperature than the first temperature, for example when the cooled syngas stream 32 increases in temperature in the first water gas shift reactor 40, then the shifted syngas stream 42 may be cooled before entering the second water gas shift reactor 50.

Carbon dioxide is removed from the further shifted syngas stream 52 in a carbon dioxide removal system 60. The carbon dioxide removal system 60 may comprise a gas scrubber in which a wash stream 64 is contacted with the further shifted syngas stream 52 to produce a carbon dioxide-depleted syngas stream 62 and carbon dioxide-enriched wash stream 66. The wash stream 64 may be any scrubbing fluid known in the art, for example N-methyl diethanolamine (aMDEA), monoethanol amine (MEA), other amine-based systems, or other scrubbing fluids associated with other scrubbing methods, for example, Rectisol®, Selexol®, Genosorb®, and Sulfinol.

The carbon dioxide-depleted syngas stream 62 is fed to an inlet port of a product purification unit 70 to produce a hydrogen-enriched product stream 72 which exits via a product outlet port and a hydrogen-depleted tail gas stream 76 comprising hydrogen, methane, and carbon monoxide, which exits via a tail gas outlet port. This product purification unit may be a pressure swing absorption unit for a hydrogen production process. In at least some embodiments, at least a portion of the tail gas stream 76 may be compressed in tail gas compressor 75 to produce a compressed tail gas stream 78.

The compressed tail gas stream 78 enters an inlet port of a membrane separation system 90 which may comprise a single membrane stage or a plurality of membrane stages in series and/or parallel. The compressed tail gas stream 78 is separated by selective permeation into a hydrogen-enriched permeate stream 92 which exits via a permeate outlet port and a hydrogen-depleted retentate stream 94 which exits via a retentate outlet port. Hydrogen selectively permeates the membrane over slower species such as methane and carbon monoxide. Owing to the small size of the hydrogen molecule, it has a high diffusivity and therefore is expected to permeate faster than methane and carbon monoxide for most membrane materials.

Sanders et al (Polymer; vol 54; pp 4729-4761; 2013) provide a convenient summary of current membrane technology. They describe the physical parameters and performance characteristics of polymeric membranes including polystyrene, polysulfone, polyethersulfone, polyvinyl fluoride, polyvinylidene fluoride, polyether ether ketone, polycarbonate, polyphenylene oxide, polyethylene, polypropylene, cellulose acetate, polyimide (such as Matrimid 5218 or P-84), polyamide, polyvinyl alcohol, polyvinyl acetate, polyethylene oxide, polydimethylsiloxane, copolymers, block copolymers, or polymer blends. Existing industrially useful gas separations are performed primarily with polymers such as those listed above or rubbery materials such as silicone. Additional membrane materials may comprise mixed-matrix membranes, perfluoropolymers, thermally rearranged polymers, facilitated transport membranes, metal-organic frameworks, zeolitic-imidazolate frameworks, electrochemical membranes, metallic membranes, and carbon molecular sieves. The membrane material in the membrane separation system 90 can be any of those listed above, or any other material that has a faster permeation rate for some compounds such as hydrogen and a slower permeation rate for some compounds such as methane and carbon monoxide. In an example implementation in which the membrane material comprises a metal highly selective to hydrogen, such as palladium, the membrane separation system 90 would operate at a high temperature, such as between 28° and 440° C.

Suitable membrane materials may be manufactured as hollow fibers and packaged as membrane bundles, or may be manufactured as flat sheets, packaged as spiral-wound or plate-and-frame units, in order to provide a larger surface area to volume ratio, and housed in a module. Gas entering the module contacts the membrane, and a fraction of the gas permeates through the membrane and leaves the module in the lower-pressure permeate stream. The faster permeating gases will be enriched in the permeate relative to the slower permeating gases. The fraction of the gas that does not permeate through the membrane leaves the module in the non-permeate, or retentate, stream which is enriched in the slower permeating gases relative to the faster permeating gases.

In at least some example implementations, compressed tail gas stream 78 may be treated prior to being introduced into membrane separation system 90 if there are any compounds present that would impair the operation of the membrane—for example heavy hydrocarbons (hexanes and heavier alkanes) and/or aromatics like benzene, toluene and xylene (collectively known as BTX). Pretreatment may be performed by adsorption, absorption, or partial condensation. In at least some embodiments, pretreatment would be unnecessary as the reforming reactions in the upstream catalyst-containing reformer tubes 104 would be expected to consume any dangerous compounds.

At least a portion of the hydrogen-enriched permeate stream 92 is combusted as fuel gas 74 in one or more burners 102 supplying heat to the reformer furnace 100 to drive the endothermic reforming reactions in the catalyst-containing reformer tubes 104. The fuel gas 74 may also comprise a tail gas fuel fraction 77 formed by dividing a portion of the hydrogen-depleted tail gas stream 76. In at least some aspects, the tail gas fuel fraction 77 may also act as a purge stream to allow slow-permeating inert components rejected by the membrane separation system 90, such as nitrogen and/or argon, to exit the system. Slow-permeating inert components are not consumed in the reforming reactions, so the primary pathway to exit the process is through the one or more burners 102. In at least some aspects, the fuel gas 74 may comprise a hydrogen product fuel fraction 73 formed by dividing a portion of the hydrogen-enriched product stream 72 and/or a supplementary fuel 18. A flue gas 110 which exits the reformer furnace 100 may provide heating duties required by the SMR process to improve the overall thermal efficiency, such as preheating the reformer feed stream 10. In accordance with at least some embodiments of the disclosure, the flue gas 110 in the disclosed process and apparatus contains a reduced amount of carbon dioxide compared to existing processes in which the hydrogen-depleted tail gas stream 76 may be combusted in the reformer furnace 100. In at least some example implementations, decreasing the flow rate of the tail gas fuel fraction 77 would increase the overall carbon capture percentage as fewer carbon-containing species exit via the flue gas 110, however the load on the product purification unit 70 will increase as more inert gas is fed to it. This presents a tradeoff in which higher carbon capture percentages require higher loads on the product purification unit 70.

The hydrogen-depleted retentate stream 94 is recycled to the steam methane reforming process by combining with the reformer feed stream 10. In at least some embodiments, the hydrogen-depleted retentate stream 94 may first be heated by one or more hot streams such as the reacted syngas stream 22, the flue gas 110, and steam. In accordance with at least some embodiments of the disclosure, recycling the hydrogen-depleted retentate stream 94 allows additional carbon-containing compounds such as methane and carbon monoxide in the retentate stream 94 to be converted to carbon dioxide and captured by the carbon dioxide removal system 60, which may reduce the amount of carbon dioxide emitted from the reforming process. The amount of carbon dioxide emissions in the flue gas 110 may be adjusted by altering the amount of hydrogen product fuel fraction 73, the amount of tail gas fuel fraction 77 and the amount of supplementary fuel 18 that are used as fuel.

In at least some aspects where most of the carbon-containing compounds in tail gas 76 are separated in the membrane separation system 90 to the hydrogen-depleted retentate stream 94 and recycled to the reforming process and the fuel gas 74 consists primarily of the hydrogen product fuel fraction 73 and the hydrogen-enriched permeate stream 92, the carbon dioxide emissions in the flue gas 110 may be substantially reduced compared to existing processes. In at least some aspects, the tail gas fuel fraction 77 may be used as fuel gas 74 to reduce the buildup of inert gases (e.g. nitrogen and argon) in the process streams. In some embodiments of the disclosure, a portion of the tail gas 76 may be used in another process and/or disposed, for example, a portion of the compressed retentate may be sent for use as fuel for another process located in proximity to the hydrogen plant, for example a fired heater or boiler.

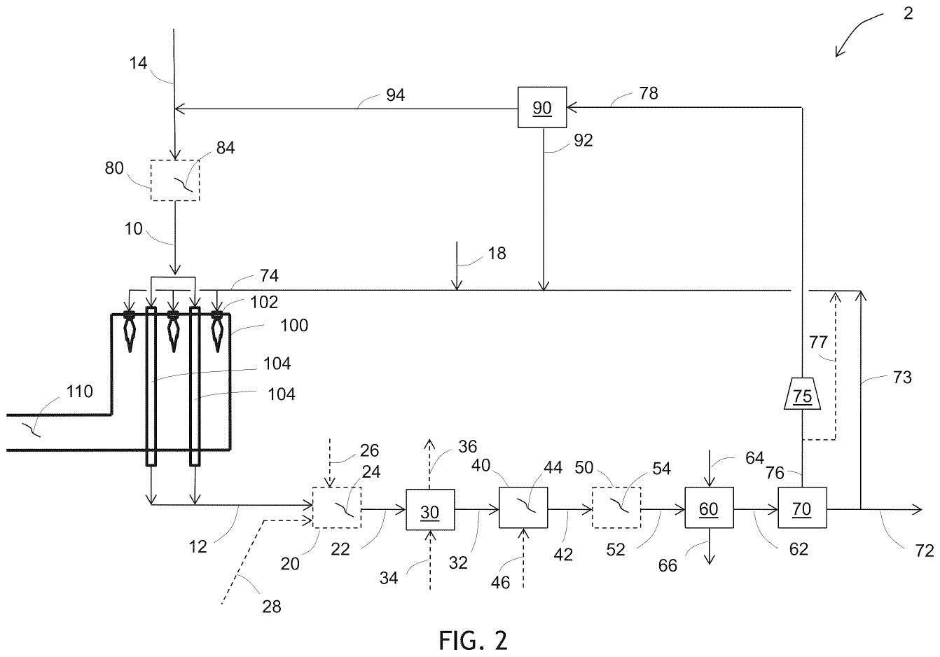

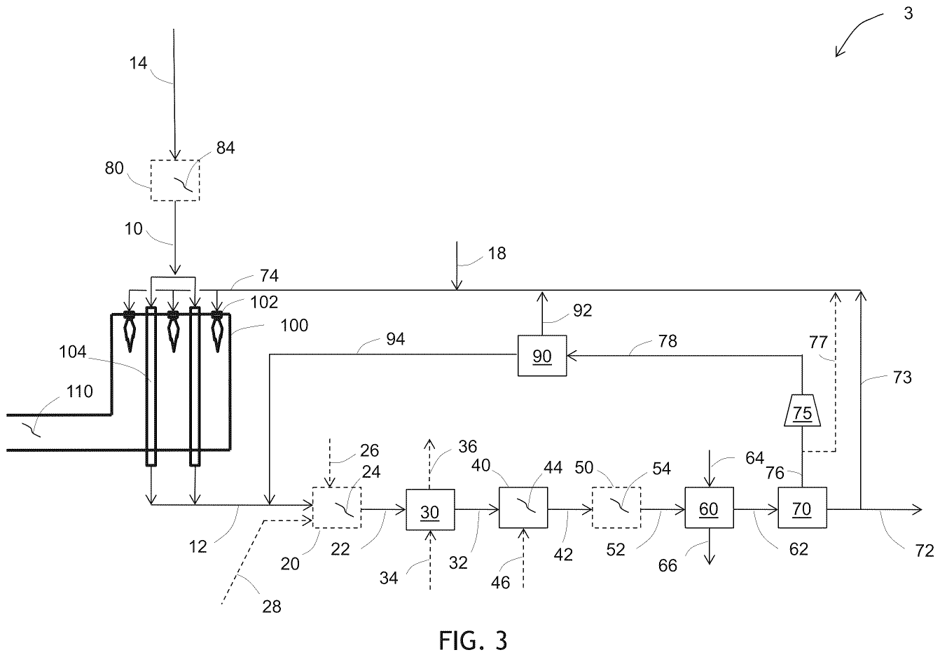

The hydrogen-depleted retentate stream 94 may be recycled to other locations, typically upstream of a reforming reactor. FIG. 2 shows an alternative embodiment of FIG. 1 in which the hydrogen-depleted retentate stream 94 is combined with the prereformer feed stream 14. FIG. 3 shows an alternative embodiment of FIG. 1 in which the hydrogen-depleted retentate stream 94 is combined with the syngas stream 12 upstream of the secondary reforming reactor 20. In at least some embodiments, the hydrogen-depleted retentate stream 94 may be combined with the cooled syngas stream 32 upstream of the first water gas shift reactor 40 or with the shifted syngas stream 42 upstream of the second water gas shift reactor 50 (not shown).

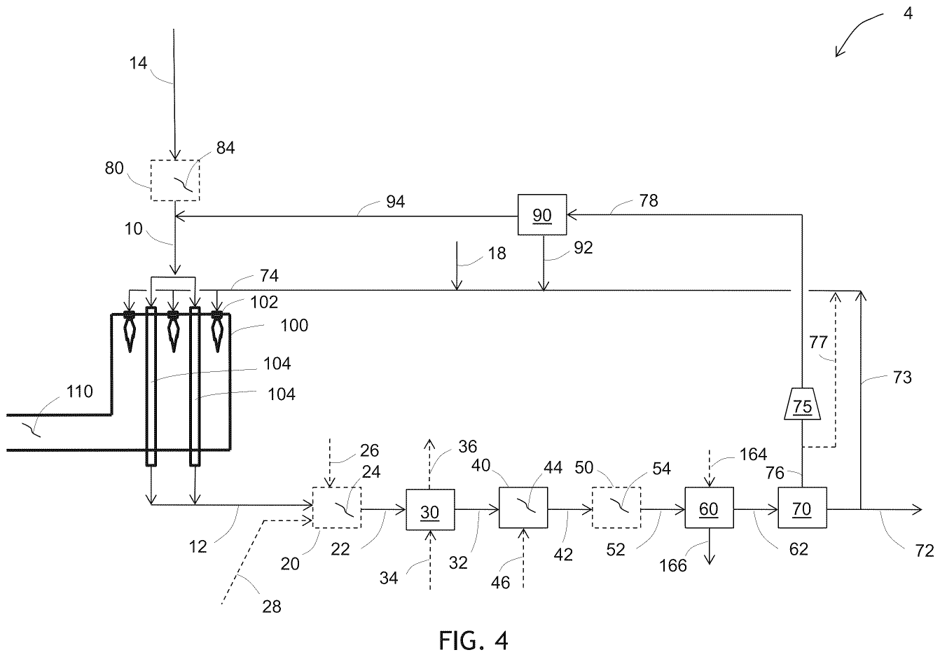

The flowsheet shown in FIG. 4 shows an embodiment of a reforming process 4 according to an additional example embodiment of the present disclosure, in which the carbon dioxide removal system 60 comprises an adsorption system such as a vacuum swing adsorption system. Hsu et al. (U.S. Pat. No. 8,709,136) teaches one such adsorption system which can be used to remove carbon dioxide from a syngas stream. The carbon dioxide-enriched blowdown gas 166 may be at a low pressure or vacuum. In at least some aspects, an optional rinse stream 164 may be used to improve recovery.

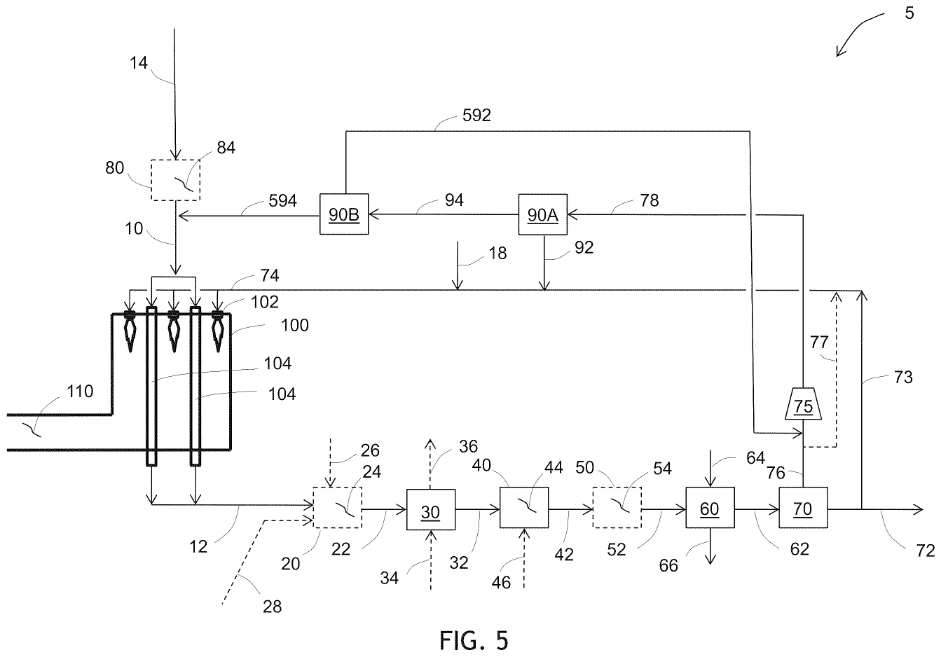

The flowsheet shown in FIG. 5 shows an embodiment of a reforming process 5 according to an additional example embodiment of the present disclosure, in which the membrane separation system comprises two stages, a first stage 90A and a second stage 90B. The hydrogen-depleted retentate stream 94 enters an inlet port of the second stage 90B. A second hydrogen-depleted retentate stream 594 exits via a second retentate outlet port and is combined with the reformer feed stream 10. A second hydrogen-enriched permeate stream 592 exits via a second permeate outlet port and may be combined with the hydrogen-depleted tail gas stream 76 upstream of the tail gas compressor 75. In accordance with at least some embodiments of the disclosure, using two stages of membrane separation may decrease the amount of hydrogen recycled to the reformer feed stream 100, improving overall efficiency of the reforming process. The tail gas compressor 75 offers an efficient point to recycle low-pressure streams exiting the membrane separation system without the cost of additional compressors.

In accordance with at least some embodiments of the disclosure, carbon dioxide capture may be enhanced by injecting more carbon dioxide into the process into any of the prereformer feed stream 14, the reformer feed stream 10, the syngas stream 12, the secondary feed stream 28, and/or the hydrogen-depleted retentate stream 94. In some aspects, carbon dioxide may partially or completely replace steam in the reforming reaction. The carbon dioxide functions as a reactant with the hydrocarbon feedstock just as steam is a reactant with the hydrocarbon feedstock in steam reforming. Effectively, dry reforming can be thought of as stoichiometrically equivalent to the combination of a steam reforming reaction and a reverse WGS reaction as shown below.

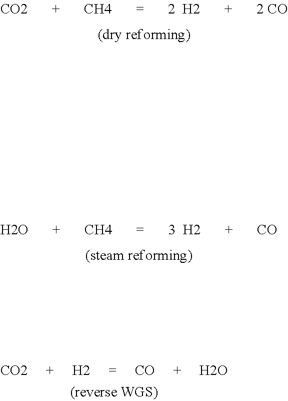

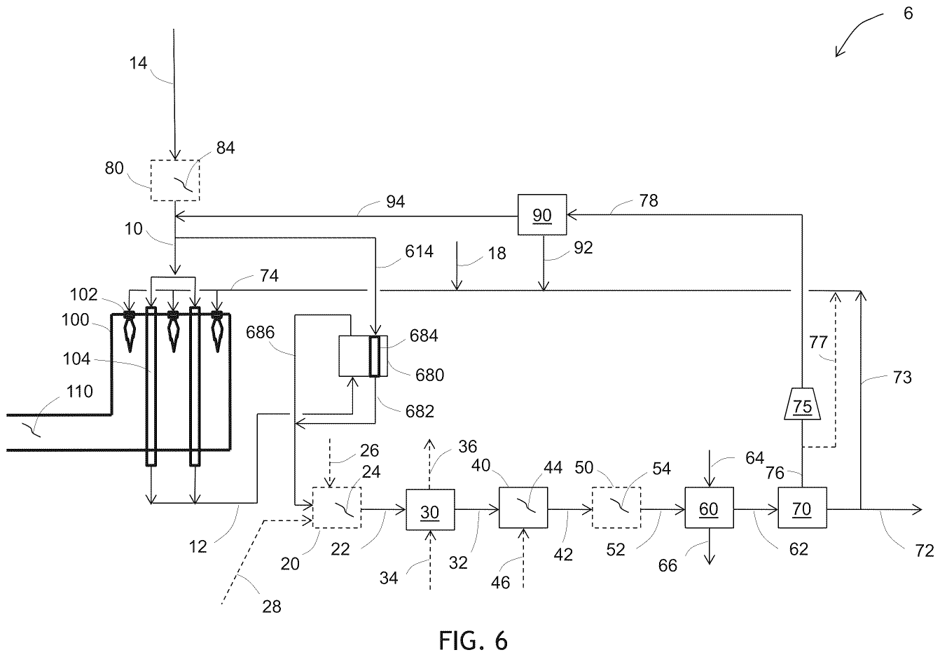

The flowsheet shown in FIG. 6 shows an embodiment of a reforming process 6 according to an additional example embodiment of the present disclosure, in which a portion of the reformer feed stream 10 is divided to form recuperative reformer feed stream 614 and fed to a recuperative reformer 680. A recuperative reformer is a heat exchanger that transfers heat to drive a catalytic reforming reaction. This allows more process heat to be used to drive more reforming reaction, of particular relevance for applications that require low or zero export steam. In at least some embodiments, steam (not shown) may be added to the recuperative reformer feed stream 614 upstream of the recuperative reformer 680. The recuperative reformer 680 may be implemented in a shell-and-tube arrangement. In the example embodiment shown in FIG. 6, the recuperative reformer feed stream 614 enters the tube side 684, which comprises a recuperative reforming catalyst, of the recuperative reformer 680. The syngas stream 12 enters the shell side to provide heat to the recuperative reformer feed stream 614 which reacts in the presence of the recuperative reforming catalyst to form a recuperative reformer outlet stream 682. The recuperative reformer outlet stream 682 is combined with cooled syngas stream 686 and may optionally feed secondary reformer 20 as in reforming process 1. In at least some embodiments, at least a portion of the hydrogen-depleted retentate stream 94 may be combined with the recuperative reformer feed stream 614 (not shown).

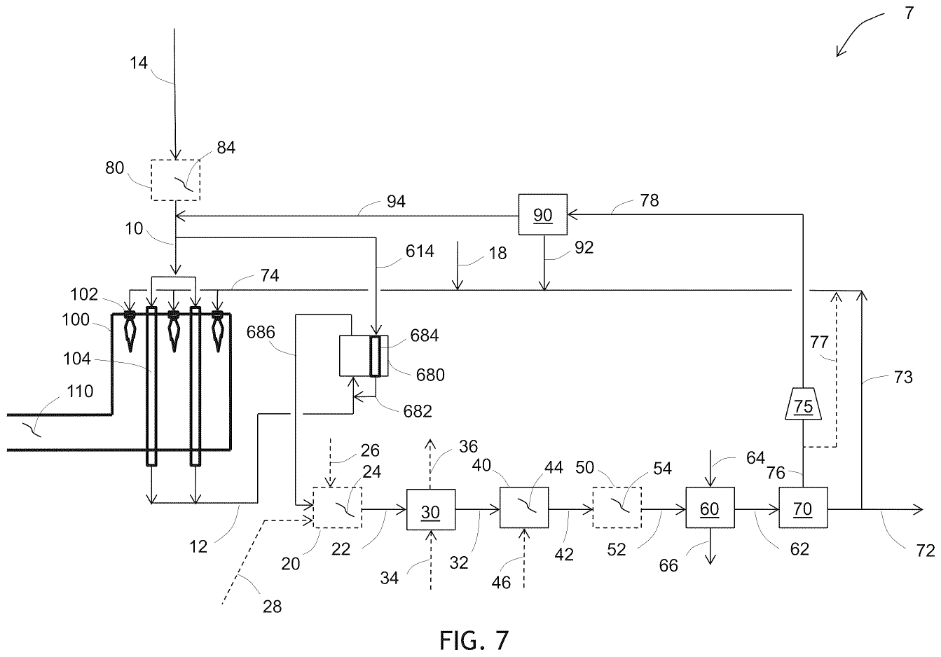

The flowsheet diagram shown in FIG. 7 shows an embodiment of a reforming process 7 according to an additional example embodiment of the present disclosure, in which the recuperative reformer outlet stream 682 is combined with the syngas stream 12 prior to entering the hot side of the recuperative reformer 680. The plumbing of the recuperative reformer may be simplified according to the example embodiment depicted, for example the mixing point of the recuperative reformer outlet stream 682 and the syngas stream 12 may occur within the recuperative reformer 680. In at least some embodiments, at least a portion of the hydrogen-depleted retentate stream 94 may be combined with the recuperative reformer feed stream 614 (not shown).

### Examples

While the principles of the disclosure have been described above in connection with preferred embodiments, it is to be clearly understood that this description is made only by way of example and not as a limitation of the scope of the disclosure.

The embodiment of reforming process 1 in FIG. 1 with a single-stage membrane was analyzed using the commerically available Aspen™ process modeling software and compared to a modification of FIG. 1 in which membrane separation system 90 is eliminated and compressed tail gas stream 78 is combined directly with reformer feed stream 10. For both processes 100,000 Nm3/hr (9000 kg/hr) of hydrogen is produced and 96% of the carbon dioxide produced in the overall process is captured. Table 1 compares the performance of the utility consumption and performance parameters of the reforming process 1 with and without a membrane. Export steam is sent to the battery limit at 750° F. and 625 psia. Derate is defined as the reduction of hydrogen production normalized to the same natural gas input compared to a process without carbon dioxide capture. The reduction of hydrogen production is effectively equal to the amount of hydrogen product that must be combusted in the burners as hydrogen product fuel fraction 73.

As can be seen in Table 1, the lower derate for reforming process 1 with membrane than without shows that less product hydrogen must be burned in the furnace when the membrane separation system 90 is employed. Correspondingly, the total natural gas consumption of reforming process 1 is also lower with the membrane. Reforming process 1 with a membrane does have a higher tail gas compressor power consumption, primarily due to the larger recycle loop causing a higher flow rate of tail gas entering the compressor. The energy cost (defined as net energy consumed in the process minus the heating value of the steam exported divided by the hydrogen production rate) is lower for reforming process 1 with a membrane. The lower export steam flow rate illustrates that the membrane separation system 90 is more efficient at converting the natural gas to hydrogen, resulting in less waste heat that is converted to steam.

TABLE 1

| | | FIG. 1 w/ | FIG. 1 w/o |
|---|---|---|---|
| | | membrane | membrane |
| Natural gas consumed | lbmol/h | 4047 | 4140 |
| H2 product fuel fraction 73 | lbmol/h | 3920 | 5564 |
| H2-depleted retentate 94 | lbmol/h | 3417 | |
| Compressed tail gas 78 | lbmol/h | | 3345 |
| Tail gas compressor 75 | kW | 8356 | 8123 |
| Export steam | lb/hr | 34372 | 41980 |
| Derate | | 29% | 36% |
| Energy cost | Net MJ/kg H2 | 165.6 | 168.7 |

1. A process for producing a hydrogen-enriched product stream, the process comprising:
reacting a reformer feed stream comprising a hydrocarbon feestock and a reactant selected from the group consisting of water and carbon dioxide in the presence of a reforming catalyst to produce a syngas stream comprising hydrogen, carbon monoxide, and carbon dioxide;
separating the syngas stream or a stream derived from the syngas stream to produce a carbon dioxide-enriched stream and a carbon dioxide-depleted stream;
separating the carbon dioxide-depleted stream to produce the hydrogen-enriched product stream and a hydrogen-depleted tail gas stream;
separating the hydrogen-depleted tail gas stream by selective permeation to produce a hydrogen-enriched permeate stream and a hydrogen-depleted retentate stream;
combusting a fuel gas to supply heat to the reaction of the reformer feed stream;
wherein the fuel gas comprises at least a portion of the hydrogen-enriched permeate stream.

2. The process of claim 1, further comprising reacting the syngas stream or a stream derived from the syngas stream in the presence of a first shift catalyst to produce a shifted syngas stream prior to separation to produce a carbon dioxide-enriched stream and a carbon dioxide-depleted stream;
wherein the syngas stream or a stream derived from the syngas stream has a first temperature.

3. The process of claim 2, further comprising reacting the shifted syngas stream in the presence of a second shift catalyst to produce a further shifted syngas stream prior to separation to produce a carbon dioxide-enriched stream and a carbon dioxide-depleted stream;
wherein the shifted syngas stream has a second temperature.

4. The process of claim 3, wherein the first temperature is greater than the second temperature.

5. The process of claim 1, wherein the reaction of the reformer feed stream takes place within a plurality of catalyst-containing reformer tubes.

6. The process of claim 1, further comprising combining at least a portion of the hydrogen-depleted retentate stream with the reformer feed stream.

7. The process of claim 1, further comprising:
combining an oxygen-rich gas with the syngas stream in the presence of a secondary reforming catalyst to partially oxidize and react the syngas stream prior to separation to produce a carbon dioxide-enriched stream and a carbon dioxide-depleted stream.

8. The process of claim 7, further comprising combining at least a portion of the hydrogen-depleted retentate stream with the syngas stream prior to combining with the oxygen-rich gas in the presence of the secondary reforming catalyst.

9. The process of claim 1, further comprising:
reacting a prereformer feed stream comprising methane and a reactant selected from the group consisting of water and carbon dioxide in the presence of a prereforming catalyst to produce the reformer feed stream.

10. The process of claim 9, further comprising combining at least a portion of the hydrogen-depleted retentate stream with the prereformer feed stream.

11. The process of claim 1, further comprising compressing the hydrogen-depleted tail gas stream prior to separation by selective permeation.

12. The process of claim 1, wherein the separation of the hydrogen-depleted tail gas stream by selective permeation also produces a second hydrogen-enriched permeate stream; and further comprising
combining the second hydrogen-enriched permeate stream with the hydrogen-depleted tail gas stream.

13. The process of claim 1, further comprising dividing at least a portion of the hydrogen-depleted tail gas stream to form a tail gas fuel fraction;
wherein the fuel gas comprises the tail gas fuel fraction.

14. An apparatus for producing a hydrogen-enriched product stream, the apparatus comprising:
a reformer comprising a reforming catalyst and one or more burners, wherein the reformer is configured to accept a reformer feed stream comprising methane and a reactant selected from the group consisting of water and carbon dioxide to contact the reforming catalyst and produce a syngas stream comprising hydrogen, carbon monoxide, and carbon dioxide;
wherein the one or more burners are configured to combust a fuel gas and transfer heat energy to the reformer feed stream in the presence of the reforming catalyst;
a carbon dioxide removal system configured to accept the syngas stream or a stream derived from the syngas stream to produce a carbon dioxide-enriched stream and a carbon dioxide-depleted stream;
a product purification system comprising an inlet port, a product outlet port, and a tail gas outlet port, configured to accept the carbon dioxide-depleted stream to produce a hydrogen-depleted tail gas stream and the hydrogen-enriched product stream;
a membrane separation system comprising an inlet port, a permeate outlet port, and a retentate outlet port, configured to accept the hydrogen-depleted tail gas stream to produce a hydrogen-enriched permeate stream and a hydrogen-depleted retentate stream;
a tail gas conduit in fluid flow communication with the tail gas outlet of the product purification system and the inlet port of the membrane separation system; and
a fuel gas conduit in fluid flow communication with the one or more burners and the permeate outlet port of the membrane separation system.

15. The apparatus of claim 14, further comprising one or more water gas shift reactors in series downstream of the reformer and upstream of the carbon dioxide removal system.

16. The apparatus of claim 14, wherein the reformer comprises a plurality of catalyst-containing reformer tubes.

17. The apparatus of claim 14, wherein the retentate outlet port of the membrane separation system is in fluid flow communication with the reformer feed stream.

18. The apparatus of claim 14, further comprising a secondary reformer located downstream of the reformer and upstream of the carbon dioxide removal system, configured to accept and partially oxidize and react the syngas stream in the presence of an oxygen-rich gas;
wherein the secondary reformer comprises a secondary reforming catalyst.

19. The apparatus of claim 18, wherein the retentate outlet port of the membrane separation system is in fluid flow communication with the syngas stream upstream of the secondary reformer.

20. The apparatus of claim 14, further comprising a prereformer located upstream of the reformer, configured to accept a prereformer feed stream comprising methane and a reactant selected from the group consisting of water and carbon dioxide to produce the reformer feed stream;
wherein the prereformer comprises a prereforming catalyst.

21. The apparatus of claim 20, wherein the retentate outlet port of the membrane separation system is in fluid flow communication with the prereformer feed stream.

22. The apparatus of claim 14, wherein the tail gas conduit comprises a tail gas compressor.

23. The apparatus of claim 14, wherein the membrane separation system comprises a second permeate outlet port;
wherein the second permeate outlet port is in fluid flow communication with the tail gas conduit.

24. The apparatus of claim 14, wherein the one or more burners are in fluid flow communication with the tail gas conduit.
